(19) United States
(12) Patent Application Publication
(10) Pub. No.: US 2024/0177284 A1
(43) Pub. Date: May 30, 2024

(54) IMAGE PROCESSING TECHNIQUES TO VALIDATE SENSOR CLEANING

(71) Applicant: GM Cruise Holdings LLC, San Francisco, CA (US)

(72) Inventors: Kilian Leport, San Francisco, CA (US); Jace Artichoker, San Francisco, CA (US); Wesley Newhouse, San Francisco, CA (US); Nicholas Decker, Sausalito, CA (US); Chin-Kai Chang, Sunnyvale, CA (US)

(21) Appl. No.: 18/072,659

(22) Filed: Nov. 30, 2022

(51) Int. Cl. G06T 7/00; B60S 1/56; G02B 27/00; G06T 7/11; G06T 7/143

(52) U.S. Cl. CPC G06T 7/0002; B60S 1/56; G02B 27/0006; G06T 7/11; G06T 7/143; G06T 2207/30168; G06T 2207/30252

(57) ABSTRACT

The disclosed technology provides solutions for confirming a sensor cleaning event of a sensor mounted on an autonomous vehicle. A method of the disclosed technology can include steps for receiving a first plurality of image frames from an optical sensor; segmenting each of the first plurality of image frames into one or more interest regions; computing image statistics for each of the one or more interest regions; generating an image mask based on the image statistics for each of the one or more interest regions; receiving a second plurality of image frames from the optical sensor; applying the image mask to the second plurality of image frames; computing image statistics for each of the second plurality of image frames; and determining a status of a sensor cleaning event based on the image statistics for each of the second plurality of image frames. Systems and machine-readable media are also provided.

### BACKGROUND

### 1. Technical Field

The disclosed technology provides solutions for confirming a sensor cleaning event of a sensor mounted on an autonomous vehicle and in particular, provides methods for analyzing images captured by a sensor mounted on an autonomous vehicle to determine the status of a sensor cleaning event based on image statistics.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV. In some instances, the collected data can be used by the AV to perform tasks relating to routing, planning and obstacle avoidance.

### BRIEF DESCRIPTION OF THE DRAWINGS

Certain features of the subject technology are set forth in the appended claims. However, the accompanying drawings, which are included to provide further understanding, illustrate disclosed aspects and together with the description explain the principles of the subject technology. In the drawings:

FIGS. 1A-1E illustrate an example image frames at various stages of processing, according to some aspects of the disclosed technology.

FIG. 2 illustrates a flow diagram of an example process for analyzing images captured by a sensor mounted on an autonomous vehicle to determine the status of a sensor cleaning event based on image statistics, according to some aspects of the disclosed technology.

FIG. 3 illustrates a flow diagram of an example process for confirming a sensor cleaning event of a sensor mounted on an autonomous vehicle, according to some aspects of the disclosed technology.

FIG. 4 illustrates an example system environment that can be used to facilitate AV dispatch and operations, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring certain concepts.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs) can navigate roadways without a human driver by using sensor signals generated by multiple sensor systems mounted at positions about the AV. In some examples, the AV sensors can comprise optical sensors, such as Light Detection and Ranging (LiDAR) sensors and cameras. In some instances, other sensors may be used, including but not limited to one or more Radio Detection and Ranging (RADAR) systems, Global Positioning System (GPS) receivers, audio sensors, Inertial Measurement Units (IMUs), and the like. AVs rely on the data provided by these sensors to make operational decisions while maneuvering through an environment. It is therefore important that the sensor's field of view is unobstructed so that the sensors can collect the most accurate and complete data about the environment. In some cases, an obstructed sensor that fails to sense an object in the environment can cause an undesirable, even dangerous, outcome as the AV traverses an environment.

One way that a sensor's field of vision can be obstructed is by accumulating debris such as dust, dirt, sand, moisture and/or any other unwanted material on the optical surface of the sensor. Sensors mounted on an AV travelling through an environment can accumulate unwanted materials (such as dirt) that negatively affect the field of vision of the sensor due to real world environment factors. For example, an AV driving through a construction zone may accumulate dust on the mounted sensors; or an AV travelling through the desert may accumulate sand on the mounted sensors. Any unwanted materials that collect on the mounted sensors can have a negative effect on the operation of the AV. Therefore, AVs can be equipped with a means of washing or cleaning the sensors during operation. In some examples, the AV can be equipped with spray nozzles mounted in proximity to the sensors that can spray the sensors with water or compressed air (or any other desirable cleaning solution) to remove unwanted debris, thereby improving the sensor's field of view and the fidelity of the collected sensor data.

In some examples, however, the cleaning system can malfunction, thereby failing to remove the unwanted debris from the sensor. In other examples, the cleaning solution container can be empty of cleaning solution, and therefore no cleaning solution can contact the sensor. Currently available AV sensors, however, lack a means of verifying if a cleaning solution has in fact contacted the surface of the sensor and removed the unwanted debris. Therefore, the present invention provides novel solutions for analyzing images captured by a sensor mounted on an AV to determine the status of a sensor cleaning event based on analyzing image statistics, including but not limited to one or more of: an average pixel brightness, a pixel brightness range, a median pixel brightness, a pixel brightness mode, and/or a pixel brightness distribution, and the like. It is understood that other image statistics may be computed, without departing from the scope of the disclosed technology.

In some examples, a sensor mounted to the AV can capture a series of images. As described in more detail below, prior to a cleaning event (spraying the sensor with a cleaning solution, for example) the captured images are stored and compared to each other to determine which image areas (or regions of interest) within the captured images are the most stable over a predetermined time period. Stable portions can be defined as portions of the image with the least amount of variation between the captured images. In some aspects, image stability can be determined or evaluated based on amount of difference (or fluctuation/stability) in pixel brightness values (or other image characteristics) e.g., from between two subsequent image frames. An image mask can then be applied to the captured images to block (or remove) portions of the captured images have been identified as unstable (e.g., that contain dynamic objects). Once the stable portions of the captured image are identified and the image mask is applied, a signal is sent to actuate a cleaning event at a predetermined time. Concurrently, the sensor that is to be cleaned (e.g., with cleaning solution or compressed air) captures a series of images as the cleaning is performed. In some examples, the same image mask previously applied to the first set of captured images is then applied to the new images (image frames) captured during the cleaning event. The reapplication of the image mask to the captured images reduces the amount of data that needs to be analyzed and aids in improving results. In some examples, applying a mask can remove the image areas that are frequently changing for reasons unrelated to a sensor cleaning event.

Subsequently, the first set of captured images (comprising an image mask) is compared to the new set of captured images (captured during and subsequent to the cleaning event, and also comprising the same image mask) to determine if there is a difference in the previously identified stable portions of the first captured images and the stable portions of the new captured images. Since spraying the sensor with cleaning solution will create a momentarily change in brightness characteristics in the new capture images (e.g., as the solution contacts the sensor), the difference in brightness can be used to infer that the cleaning solution has contacted the sensor.

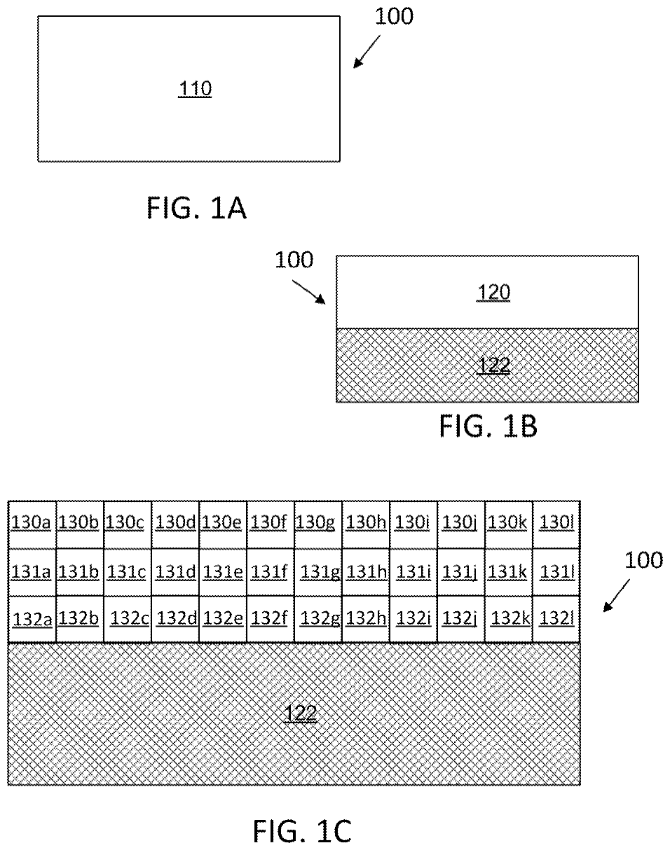

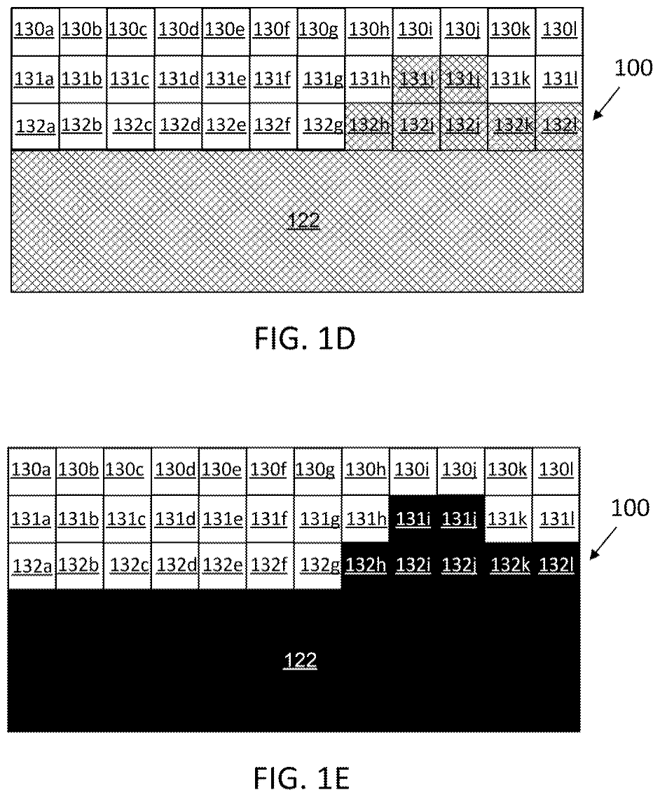

FIGS. 1A-1E illustrate an example image frame at various stages of processing according to some aspects of the disclosed technology. FIG. 1A illustrates an example image frame 100 comprising image 110. In some examples, image frame 100 is an image captured by a sensor mounted on an AV. The image frame 100 comprises an image 110 including data relating to a captured scene from an environment. For example, the image 110 can comprise data showing a scene as the AV travels along a roadway, wherein the scene includes people, buildings, trees, other vehicles, and/or any other objects that can exist in the environment. The sensors capture a plurality of image frames 100 as the AV travels. These image frames 100 comprising image 110 can be stored in the memory of the AV for subsequent analysis.

FIG. 1B illustrates an example image frame 100 comprising top image portion 120 and bottom image portion 122. As shown in FIG. 1B, in some examples, after the sensor has captured and stored image frame 100 comprising image 110, the AV controller can divide the image 110 into a top portion 120 and into a bottom portion 122. The AV controller can subsequently remove the bottom image portion 122 from each image frame 100. In some examples, the bottom portion 122 of the image is removed from the image because it is the least stable portion of the captured image, e.g., it is the image portion that is most likely to contain dynamic objects. For example, the bottom portion of a captured image is more likely to contain moving objects than the top portion because the bottom portion is more likely to include people, vehicles, bikes, etc. while the top portion can mostly include the sky, clouds, etc. In some examples, a different portion than the bottom portion 122 of the image frame 100 can alternatively be removed. Specifically, in some scenarios, the AV controller can determine which portion of the image frame 100 remains stationary over a given time period and subsequently remove the remaining (or non-stationary) portion of image frame 100. It is contemplated that any portion of the image frame 100 that is determined to not be stationary by the AV controller can be removed from the image frame 100 at this step. Various sensors positioned at different positions about the AV can result in different regions that are stationary based at least on the aim and positioning of the sensor.

FIG. 1C illustrates an example image frame 100 wherein the top image portion has been segmented into interest regions 130a-130l, 131a-131l, and 132a-132l. In some examples, the AV controller can segment the top image portion into interest regions to further remove any unstable portions of the image and aid in faster and improved analysis. In some examples, the interest regions 130a-130l, 131a-131l, and 132a-132l each have the same size and area while in other example, the interest regions can be variably sized. While FIG. 1C illustrates 36 individual interest regions (i.e., 130a-130l, 131a-131l, and 132a-132l), it is contemplated that any number of interest regions, in any size or orientation, can be used.

FIG. 1D illustrates an example image frame 100 wherein several of the segmented interest regions (i.e., interest regions 131i-131j and 132h-132l) have been removed. As discussed above with respect to FIG. 1B, the bottom portion of the image can be removed from the image since it is the least stable portion of the captured image. Likewise, in FIG. 1D, interest regions 131i-131j and 132h-132l have been removed from image frame 100 because it was determined that those interest regions (i.e., interest regions 131i-131j and 132h-132l) are not stable. In some examples, corresponding interest regions of each captured image are compared between the plurality of image frames to determine whether an interest region is stable. For example, if a tall person if wandering in and out of view of the sensors, the top of the tall person's head can be captured by some images, but not captured in other images. In this example, the top of the tall person's head appears in interest regions 131i-131j and 132h-132l in some captured images, but not others. Therefore, it is determined that interest regions 131i-131j and 132h-132l are not stable. Any moving object that enters and exits the view of the sensor can have the same effect and create unstable interest regions.

In some examples, the process of determining which interest regions are stable and which interest regions are not stable (and therefore can be removed from the image) requires processing the captured images. The process can isolate the determined stable portions of the captured images in order to create a steady state scene that is more easily and efficiently analyzed. In some examples, the captured images are converted to grayscale and a brightness value is determined for each interest region. The brightness value can be computed using a one-dimensional pixel array to find an average value of each interest region. This brightness value associated with each interest region is then compared to the corresponding brightness value associated with each interest region of the plurality of captured images. In some examples, if the difference between the brightness values calculated for corresponding interest regions between the plurality of captured images is larger than a predetermined threshold, then the interest region can be considered unstable. This unstable interest region can subsequently be removed form the captured images.

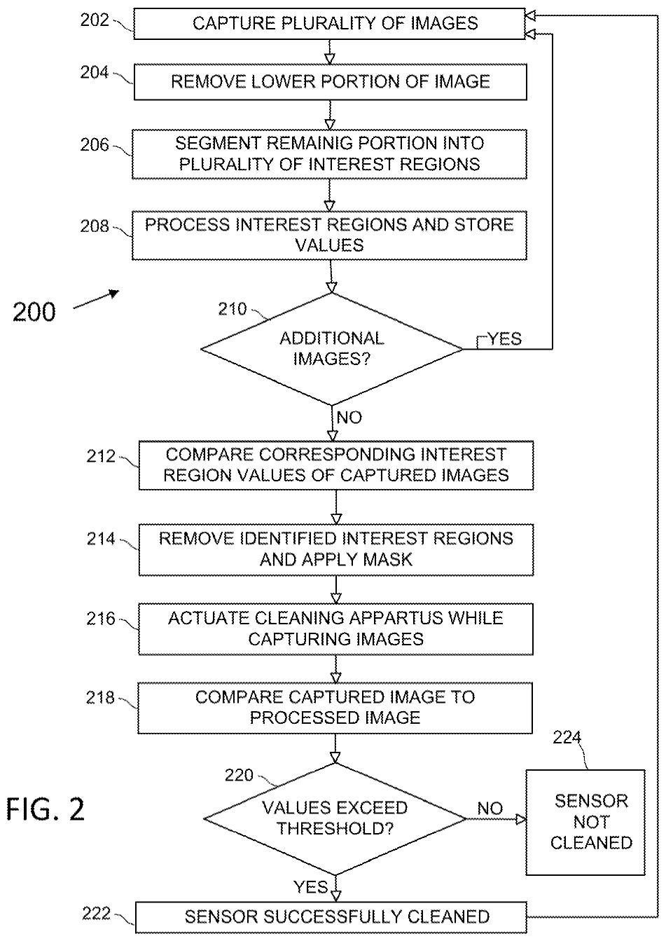

FIG. 1E illustrates an example image frame 100 wherein an image mask (shown in black) has been applied to captured image 100. In some examples, after a plurality of captured images have been processed to remove the unstable interest regions, an image mask can be applied to the captured images so that the unstable interest regions are covered up and not further analyzed. As discussed above, any moving object that enters and exits the view of the sensor can create unstable interest regions. As described in more detail below with regard to FIG. 2, the image mask will subsequently be applied to images captured during (and after) the actuation of a cleaning event so that only the image regions determined to be stable are compared.

FIG. 2 illustrates a flow diagram of an example process for analyzing images captured by a sensor mounted on an autonomous vehicle to determine the status of a sensor cleaning event based on image statistics, according to some aspects of the disclosed technology. At block 202, process 200 can include the AV (e.g., AV 102) using mounted sensors to capture a plurality of images (i.e. image frame 100). In some examples, these captured images are stored in memory for subsequent analysis.

At block 204, the process 200 can include removing the bottom portion (i.e., bottom portion 122) of each of the plurality of images (i.e., image frame 100). As discussed above with respect to FIG. 1B, in some examples, after the sensor has captured and stored image 100 comprising image 110, the AV controller can divide the image 110 into top portion 120 and into a bottom portion 122. The AV controller can subsequently remove the bottom image portion 122 from each image frame 100. In some examples, the bottom portion of the image is removed from the image because it is the least stable portion of the captured image. For example, the bottom portion of a captured image is more likely to contain moving objects than the top portion because the bottom portion is more likely to include people, vehicles, bikes, etc. while the top portion can mostly include the sky, clouds, etc.

At block 206, the process 200 can include segmenting the remaining top portion of each of the plurality of images (i.e. image frame 100) into a plurality of interest regions (i.e. interest regions 130a-130l, 131a-131l, and 132a-132l). In some examples, the AV controller can segment the top image portion into interest regions to identify any unstable portions of the image that can be removed. As discussed above, in some examples, the interest regions 130a-130l, 131a-131l, and 132a-132l each have the same size and area, and any number of interest regions, in any size or orientation, can be used.

At block 208, the process 200 can include processing the plurality of interest regions (i.e. interest regions 130a-130l, 131a-131l, and 132a-132l) to determine which interest regions are unstable, and storing the calculated values. In some examples, the processing of the interest regions can include converting the captured images to grayscale and determining a brightness value for each interest region. The brightness value can be computed using a one-dimensional pixel array to find an average value of each interest region.

At block 210, the process 200 can include determining whether additional images are necessary to have sufficient data to compare subsequent image captures. If the AV needs more data, the process returns to block 202 and additional images are captured. Alternatively, if the AV has sufficient data, the process continues to block 212. Some environments can require more captured images than other environments in order to effectively identify and isolate stable interest regions can require processing a plurality of images. For example, an AV located on a crowded urban boulevard may require more captured images than an AV located on a deserted a desert highway.

At block 212, the process 200 can include comparing the corresponding interest regions of the plurality of captured images to determine which interest regions are stable. As discussed above, in some examples, a tall object entering and exiting the field of view of the sensors can be captured by some images, but not captured in other images. In such a scenario, it can be determined that the interest regions affected by this tall object are not stable. Any moving object that enters and exits the view of the sensor can have the same effect and create unstable interest regions. In some examples, the identified brightness value associated with each interest region can be compared to the corresponding brightness value associated with each interest region of the plurality of captured images. In some examples, if the difference between the brightness values calculated for corresponding interest regions between the plurality of captured images is larger than a predetermined threshold, then the interest region can be considered unstable.

At block 214, the process 200 can include removing the interest regions identified as unstable and applying an image mask. As discussed with regard to FIG. 1D, interest regions 131i-131j and 132h-132l can be removed from image frame 100 if it is determined that those interest regions (i.e. interest regions 131i-131j and 132h-132l) are not stable. In some examples, after the plurality of captured images have been processed to remove the unstable interest regions, an image mask can be applied to the captured images so that the unstable interest regions are covered up and not further analyzed.

At block 216, the process 200 can include actuating a cleaning apparatus while continuing to capture images. In some examples, the cleaning apparatus is a nozzle that sprays water (or any suitable cleaning solution) on the sensor. It is contemplated that any apparatus capable of delivering a cleaning solution to the sensor can be used. In some examples, while the cleaning apparatus is delivering the cleaning solution to the sensor, the sensor can continue to capture images. As discussed below, the images captured at the time of the actuation of the cleaning apparatus will be used to determine the status of the cleaning event.

At block 218, the process 200 can include comparing the plurality of images captured during (and after) the cleaning event to the previously processed plurality of images. In some examples, the image mask applied to the previously processed plurality of images can be applied to the newly captured images. Using the same image mask on both sets of captured images reduces the amount of data that must be compared and also focused the comparison on stable data. Because the scene is generally the same in both sets of images, the portions of the image determined stable in the first set of captured images generally corresponds to the same stable portions of the newly captured images. In some examples, interest regions of the newly captures images are processed to determine brightness values in the same manner as the original images were processed. These brightness values are compared to each other to determine whether a change has occurred.

At block 220, the process 200 can include determining whether the difference between the calculated brightness values of the original captured images and the newly captured images exceeds a predetermined threshold. In some examples, the threshold can be dynamically determined based on previously collected statistics. In some examples, when the cleaning fluid contacts the sensor, it causes the captured image to be much brighter than the previous images for a short time. In some examples, when the cleaning fluid contacts the sensor, it causes the captured image to be much darker than the previous images for a short time. In some examples, the threshold difference between the brightness values is determined to account for the difference in brightness between the original scene and the expected brightness of the cleaning solution. In either scenario (i.e., whether the cleaning fluid contacting the sensor causes the captured image to be much brighter than the previous images, or alternatively whether the cleaning fluid contacting the sensor causes the captured image to be much darker than the previous images), the process can determine when the difference between the calculated brightness values of the original captured images and the newly captured images exceeds a predetermined threshold.

At block 222, the process 200 can include indicating that the sensor has been cleaned. In some examples, the process 200 can return to block 202, wherein the AV (e.g., AV 102) can continue to use mounted sensors to capture a plurality of image frames (i.e. image frame 100) as discussed above, and repeat the process 200. At block 224, the process 200 can include indicating that the sensor has not been cleaned. In some examples, if it is determined that the sensor has not been cleaned, a light or other indicator can be present indicating that the cleaning apparatus needs troubleshooting. In some examples, a determination that the sensor has not been cleaned can trigger a retest or manual investigation of the failed parts. In some examples, a determination that the sensor has not been cleaned can trigger sending a message to an administrator. In some examples, a determination that the sensor has not been cleaned can result in reducing the capabilities of the AV based on the determination that the sensor or camera is not usable. In some examples, a determination that the sensor has not been cleaned can result in modifying the AV stack to rely on other sensors more heavily while the sensor or camera that was determined to not be clean.

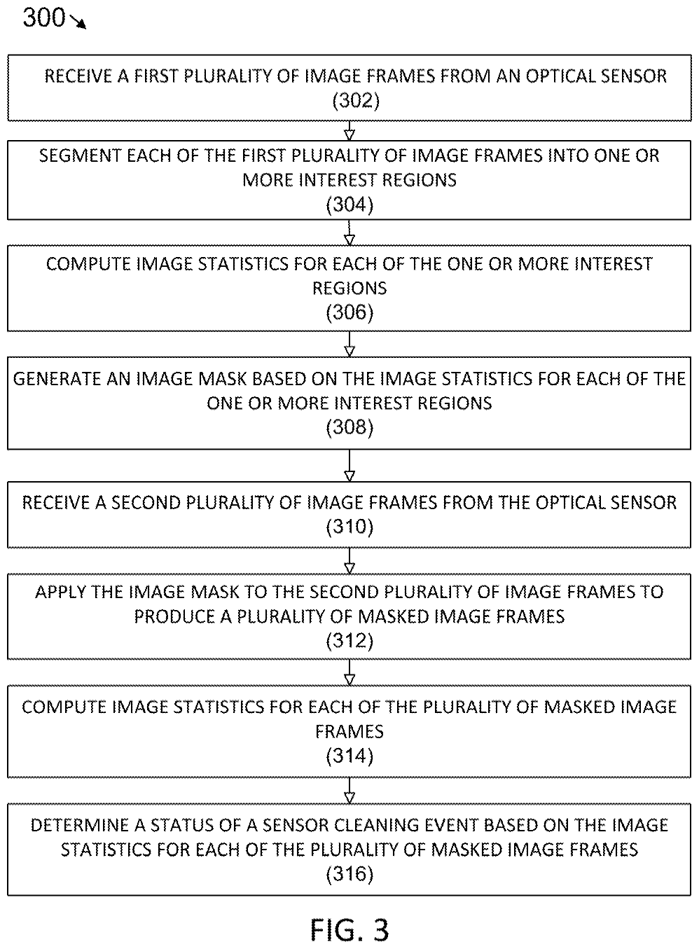

FIG. 3 illustrates a flow diagram of an example process for confirming a sensor cleaning event of a sensor mounted on an autonomous vehicle, according to some aspects of the disclosed technology. At block 302, the process 300 can include receiving a first plurality of image frames (i.e. image frame 100) from an optical sensor. In some examples, these plurality of images are stored in memory for subsequent analysis.

At block 304, the process 300 can include segmenting each of the first plurality of image frames into one or more interest regions (i.e. interest regions 130a-130l, 131a-131l, and 132a-132l). In some examples, the AV controller can segment a portion of the image into interest regions to remove any unstable portions of the image and aid in faster and improved analysis. As discussed above, while FIG. 1C illustrates 36 individual interest regions (i.e. 130a-130l, 131a-131l, and 132a-132l), it is contemplated that any number of interest regions, in any size or orientation, can be used.

At block 306, the process 300 can include computing image statistics for each of the one or more interest regions. As discussed above, in some examples, image statistics include but are not limited to one or more of: an average pixel brightness, a pixel brightness range, a median pixel brightness, a pixel brightness mode, and/or a pixel brightness distribution, and the like. It is understood that other image statistics may be computed, without departing from the scope of the disclosed technology. In some examples, the process determines which interest regions are stable and which interest regions are not stable (and therefore can be removed from the image). The process can isolate the determined stable portions of the captured images in order to create a steady state scene that is more easily and efficiently analyzed. In some examples, the captured images are converted to grayscale and a brightness value is determined for each interest region. The brightness value can be computed using a one-dimensional pixel array to find an average value of each interest region.

At block 308, the process 300 can include generating an image mask based on the image statistics for each of the one or more interest regions. In some examples, after the plurality of captured images have been processed to remove the unstable interest regions, an image mask can be applied to the captured images (as shown in FIG. 1E) so that the unstable interest regions are covered up and not further analyzed. In some examples, applying a mask can remove the image areas that are frequently changing for reasons unrelated to a sensor cleaning event.

At block 310, the process 300 can include receiving a second plurality of image frames from the optical sensor. In some examples, while the cleaning apparatus is delivering the cleaning solution to the sensor, the sensor can capture a second plurality of image frames from the optical sensor. In some examples, the cleaning apparatus can be a nozzle that sprays water (or any suitable cleaning solution) on the sensor. It is contemplated that any apparatus capable of delivering a cleaning solution to the sensor can be used.

At block 312, the process 300 can include applying the image mask to the second plurality of image frames to produce a plurality of masked image frames. In some examples, applying the same image mask on both sets of captured images reduces the amount of data that must be compared and also focused the comparison on stable data. Because the scene is generally the same in both sets of images, the portions of the image determined stable in the first set of captured images generally corresponds to the same stable portions of the newly captured images.

At block 314, the process 300 can include computing image statistics for each of the plurality of masked image frames. In some examples, image statistics can include but are not limited to one or more of: an average pixel brightness, a pixel brightness range, a median pixel brightness, a pixel brightness mode, and/or a pixel brightness distribution, and the like. It is understood that other image statistics may be computed, without departing from the scope of the disclosed technology. In some examples, computing image statistics can include converting the second plurality of image frames to grayscale and determining a brightness value for each interest region. In some examples, the brightness value can be computed using a one-dimensional pixel array to find an average value of each interest region.

At block 316, the process 300 can include determining a status of a sensor cleaning event based on the image statistics for each of the plurality of masked image frames. In some examples, interest regions of the second plurality of image frames are processed to determine brightness values in the same manner as the first plurality of image frames were processed. These brightness values are compared to each other to determine a difference that indicates whether a change has occurred. Specifically, the difference between the calculated brightness values of the first plurality of image frames and the second plurality of image frames are compared to determine whether the difference exceeds a predetermined threshold. In some examples, when the cleaning fluid contacts the sensor, it causes the captured image to be much brighter than the previous images for a short time. In some examples, when the cleaning fluid contacts the sensor, it causes the captured image to be much darker than the previous images for a short time. In some examples, the threshold difference between the brightness values is determined to account for the difference in brightness between the original scene and the expected brightness of the cleaning solution. In some examples, if the difference exceeds the predetermined threshold, a status of the sensor cleaning event is determined. In some examples, the status can indicate whether the cleaning solution made contact with the sensor.

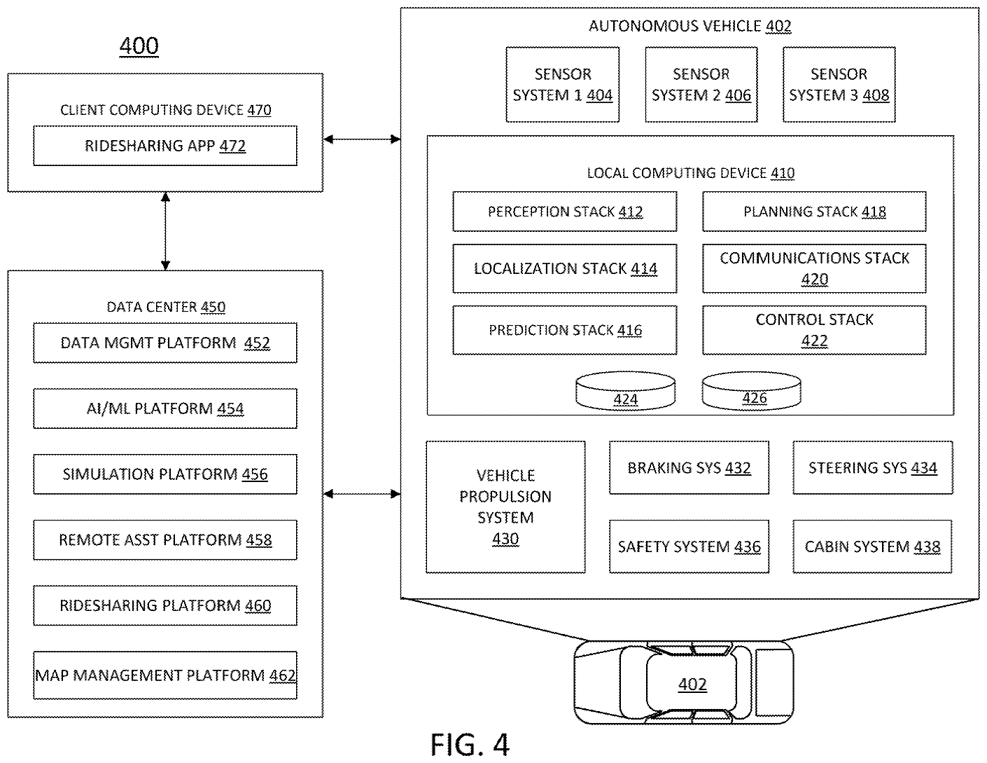

FIG. 4 illustrates an example of an AV management system 400. One of ordinary skill in the art will understand that, for the AV management system 400 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 400 includes an AV 402, a data center 150, and a client computing device 170. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 402 can navigate roadways without a human driver based on sensor signals generated by multiple sensor systems 404, 406, and 408. The sensor systems 404-408 can include different types of sensors and can be arranged about the AV 402. For instance, the sensor systems 404-408 can comprise Inertial Measurement Units (IMUs), cameras (e.g., still image cameras, video cameras, etc.), optical sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LIDAR system, and the sensor system 408 can be a RADAR system. Other embodiments may include any other number and type of sensors.

The AV 402 can also include several mechanical systems that can be used to maneuver or operate the AV 402. For instance, the mechanical systems can include a vehicle propulsion system 430, a braking system 432, a steering system 434, a safety system 436, and a cabin system 438, among other systems. The vehicle propulsion system 430 can include an electric motor, an internal combustion engine, or both. The braking system 432 can include an engine brake, brake pads, actuators, and/or any other suitable componentry configured to assist in decelerating the AV 402. The steering system 434 can include suitable componentry configured to control the direction of movement of the AV 402 during navigation. The safety system 436 can include lights and signal indicators, a parking brake, airbags, and so forth. The cabin system 438 can include cabin temperature control systems, in-cabin entertainment systems, and so forth. In some embodiments, the AV 402 might not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

The AV 402 can additionally include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a mapping and localization stack 414, a prediction stack 416, a planning stack 418, a communications stack 420, a control stack 422, an AV operational database 424, and an HD geospatial database 426, among other stacks and systems.

The perception stack 412 can enable the AV 402 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the mapping and localization stack 414, the HD geospatial database 426, other components of the AV, and other data sources (e.g., the data center 450, the client computing device 470, third party data sources, etc.). The perception stack 412 can detect and classify objects and determine their current locations, speeds, directions, and the like. In addition, the perception stack 412 can determine the free space around the AV 402 (e.g., to maintain a safe distance from other objects, change lanes, park the AV, etc.). The perception stack 412 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Mapping and localization stack 414 can determine the AV's position and orientation (pose) using different methods from multiple systems (e.g., GPS, IMUs, cameras, LIDAR, RADAR, ultrasonic sensors, the HD geospatial database 426, etc.). For example, in some embodiments, AV 402 can compare sensor data captured in real-time by sensor systems 404-408 to data in HD geospatial database 426 to determine its precise (e.g., accurate to the order of a few centimeters or less) position and orientation. AV 402 can focus its search based on sensor data from one or more first sensor systems (e.g., GPS) by matching sensor data from one or more second sensor systems (e.g., LIDAR). If the mapping and localization information from one system is unavailable, AV 402 can use mapping and localization information from a redundant system and/or from remote data sources.

Prediction stack 416 can receive information from localization stack 414 and objects identified by perception stack 412 and predict a future path for the objects. In some embodiments, prediction stack 416 can output several likely paths that an object is predicted to take along with a probability associated with each path. For each predicted path, prediction stack 416 can also output a range of points along the path corresponding to a predicted location of the object along the path at future time intervals along with an expected error value for each of the points that indicates a probabilistic deviation from that point.

Planning stack 418 can determine how to maneuver or operate AV 402 safely and efficiently in its environment. For example, planning stack 418 can receive the location, speed, and direction of AV 402, geospatial data, data regarding objects sharing the road with AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another and outputs from the perception stack 412, localization stack 414, and prediction stack 416. Planning stack 418 can determine multiple sets of one or more mechanical operations that AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 418 can select from multiple backup plans to carry out. For example, while preparing to change lanes to turn right at an intersection, another vehicle may aggressively cut into the destination lane, making the lane change unsafe. The planning stack 418 could have already determined an alternative plan for such an event. Upon its occurrence, it could help direct AV 402 to go around the block instead of blocking a current lane while waiting for an opening to change lanes.

Control stack 422 can manage the operation of the vehicle propulsion system 430, the braking system 432, the steering system 434, the safety system 436, and the cabin system 438. Control stack 422 can receive sensor signals from the sensor systems 404-408 as well as communicate with other stacks or components of the local computing device 410 or a remote system (e.g., the data center 450) to effectuate operation of AV 402. For example, control stack 422 can implement the final path or actions from the multiple paths or actions provided by planning stack 418. This can involve turning the routes and decisions from planning stack 418 into commands for the actuators that control the AV's steering, throttle, brake, and drive unit.

Communications stack 420 can transmit and receive signals between the various stacks and other components of AV 402 and between AV 402, data center 450, client computing device 470, and other remote systems. Communications stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 420 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

HD geospatial database 426 can store HD maps and related data of the streets upon which the AV 402 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 424 can store raw AV data generated by the sensor systems 404-408, stacks 412-422, and other components of AV 402 and/or data received by AV 402 from remote systems (e.g., data center 450, client computing device 470, etc.). In some embodiments, the raw AV data can include HD LIDAR point cloud data, image data, RADAR data, GPS data, and other sensor data that data center 450 can use for creating or updating AV geospatial data or for creating simulations of situations encountered by AV 402 for future testing or training of various machine learning algorithms that are incorporated in local computing device 410.

Data center 450 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. Data center 450 can include one or more computing devices remote to local computing device 410 for managing a fleet of AVs and AV-related services. For example, in addition to managing AV 402, data center 450 may also support a ridesharing service, a delivery service, a remote/roadside assistance service, street services (e.g., street mapping, street patrol, street cleaning, street metering, parking reservation, etc.), and the like.

Data center 450 can send and receive various signals to and from AV 402 and client computing device 470. These signals can include sensor data captured by the sensor systems 404-408, roadside assistance requests, software updates, ridesharing pick-up and drop-off instructions, and so forth. In this example, data center 450 includes a data management platform 452, an Artificial Intelligence/Machine Learning (AI/ML) platform 454, a simulation platform 456, a remote assistance platform 458, and a ridesharing platform 460, and a map management platform 462, among other systems.

Data management platform 452 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 450 can access data stored by the data management platform 452 to provide their respective services.

AI/ML platform 454 can provide the infrastructure for training and evaluating machine learning algorithms for operating AV 402, the simulation platform 456, the remote assistance platform 458, the ridesharing platform 460, the map management platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

Simulation platform 456 can enable testing and validation of the algorithms, machine learning models, neural networks, and other development efforts for AV 402, remote assistance platform 458, ridesharing platform 460, map management platform 462, and other platforms and systems. The simulation platform 456 can replicate a variety of driving environments and/or reproduce real-world scenarios from data captured by AV 402, including rendering geospatial information and road infrastructure (e.g., streets, lanes, crosswalks, traffic lights, stop signs, etc.) obtained from a cartography platform (e.g., map management platform 462); modeling the behavior of other vehicles, bicycles, pedestrians, and other dynamic elements; simulating inclement weather conditions, different traffic scenarios; and so on.

Remote assistance platform 458 can generate and transmit instructions regarding the operation of the AV 402. For example, in response to an output of the AI/ML platform 454 or other system of data center 450, remote assistance platform 458 can prepare instructions for one or more stacks or other components of AV 402.

Ridesharing platform 460 can interact with a customer of a ridesharing service via a ridesharing application 472 executing on client computing device 470. The client computing device 470 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing ridesharing application 472. Client computing device 470 can be a customer's mobile computing device or a computing device integrated with the AV 402 (e.g., the local computing device 410). The ridesharing platform 460 can receive requests to pick up or drop off from the ridesharing application 472 and dispatch the AV 402 for the trip.

Map management platform 462 can provide a set of tools for the manipulation and management of geographic and spatial (geospatial) and related attribute data. The data management platform 452 can receive LIDAR point cloud data, image data (e.g., still image, video, etc.), RADAR data, GPS data, and other sensor data (e.g., raw data) from one or more AVs 402, Unmanned Aerial Vehicles (UAVs), satellites, third-party mapping services, and other sources of geospatially referenced data. The raw data can be processed, and map management platform 462 can render base representations (e.g., tiles (2D), bounding volumes (3D), etc.) of the AV geospatial data to enable users to view, query, label, edit, and otherwise interact with the data. Map management platform 462 can manage workflows and tasks for operating on the AV geospatial data. Map management platform 462 can control access to the AV geospatial data, including granting or limiting access to the AV geospatial data based on user-based, role-based, group-based, task-based, and other attribute-based access control mechanisms. Map management platform 462 can provide version control for the AV geospatial data, such as to track specific changes that (human or machine) map editors have made to the data and to revert changes when necessary. Map management platform 462 can administer release management of the AV geospatial data, including distributing suitable iterations of the data to different users, computing devices, AVs, and other consumers of HD maps. Map management platform 462 can provide analytics regarding the AV geospatial data and related data, such as to generate insights relating to the throughput and quality of mapping tasks.

In some embodiments, the map viewing services of map management platform 462 can be modularized and deployed as part of one or more of the platforms and systems of data center 450. For example, the AI/ML platform 454 may incorporate the map viewing services for visualizing the effectiveness of various object detection or object classification models, simulation platform 456 may incorporate the map viewing services for recreating and visualizing certain driving scenarios, remote assistance platform 458 may incorporate the map viewing services for replaying traffic incidents to facilitate and coordinate aid, ridesharing platform 460 may incorporate the map viewing services into client application 472 to enable passengers to view AV 402 in transit en route to a pick-up or drop-off location, and so on.

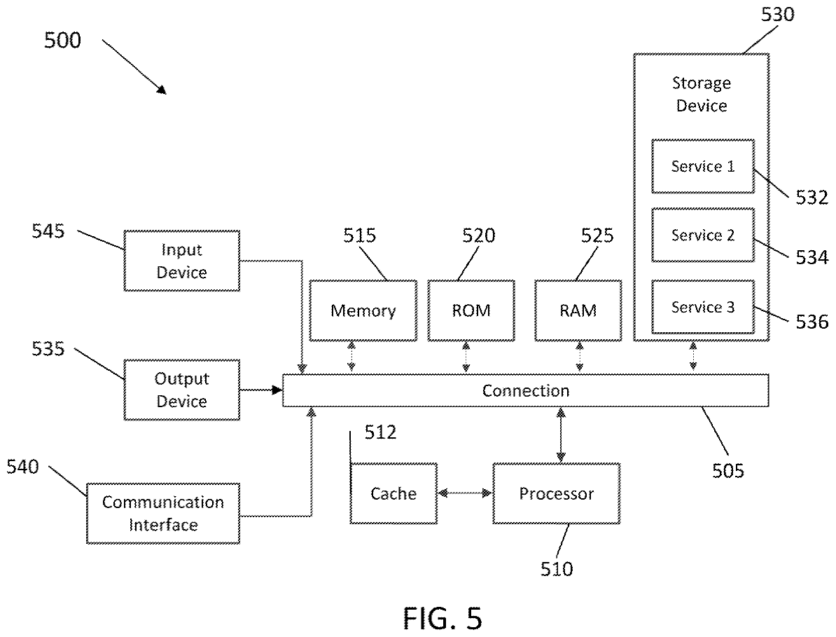

FIG. 5 illustrates an example apparatus (e.g., a processor-based system) with which some aspects of the subject technology can be implemented. For example, processor-based system 500 can be any computing device making up internal computing system 410, remote computing system 450, a passenger device executing the rideshare app 470, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

Computing system 500 can be (or may include) a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L6), resistive random-access memory (RRAM/ReRAM), phase change memory (PCM), spin transfer torque RAM (STT-RAM), another memory chip or cartridge, and/or a combination thereof.

Storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. An apparatus comprising: at least one memory; and at least one processor coupled to the at least one memory, the at least one processor configured to: receive a first plurality of image frames from an optical sensor; segment each of the first plurality of image frames into one or more interest regions; compute image statistics for each of the one or more interest regions; generate an image mask based on the image statistics for each of the one or more interest regions; receive a second plurality of image frames from the optical sensor; apply the image mask to the second plurality of image frames to produce a plurality of masked image frames; compute image statistics for each of the plurality of masked image frames; and determine a status of a sensor cleaning event based on the image statistics for each of the plurality of masked image frames.

Aspect 2. The apparatus of Aspect 1, wherein the second plurality of image frames are received in response to an indication that the sensor cleaning event has been initiated.

Aspect 3. The apparatus of Aspect 1 or 2, wherein the sensor cleaning event is initiated in response to a determination that one or more interest regions of the second plurality of images are stable.

Aspect 4. The apparatus of any of Aspects 1 to 3, wherein to compute the image statistics for each of the first plurality of image frames based on the one or more interest regions, the at least one processor is further configured to: generate a one-dimensional pixel array for each of the first plurality of image frames; and compute the image statistics for each of the first plurality of image frames based on the corresponding one-dimensional pixel array.

Aspect 5. The apparatus of any of Aspects 1 to 4, wherein the sensor cleaning event is associated with timestamp metadata.

Aspect 6. The apparatus of any of Aspects 1 to 5, wherein the sensor cleaning event comprises applying a cleaning solution to an optical lens of the optical sensor.

Aspect 7. The apparatus of any of Aspects 1 to 6, wherein the optical sensor is a camera sensor.

Aspect 8. A computer-implemented method for confirming a sensor cleaning event, comprising: receiving a first plurality of image frames from an optical sensor; segmenting each of the first plurality of image frames into one or more interest regions; computing image statistics for each of the one or more interest regions; generating an image mask based on the image statistics for each of the one or more interest regions; receiving a second plurality of image frames from the optical sensor; applying the image mask to the second plurality of image frames to produce a plurality of masked image frames; computing image statistics for each of the plurality of masked image frames; and determining a status of a sensor cleaning event based on the image statistics for each of the plurality of masked image frames.

Aspect 9. The computer-implemented method of Aspect 8, wherein the second plurality of image frames are received in response to an indication that the sensor cleaning event has been initiated.

Aspect 10. The computer-implemented method of Aspect 8 or 9, wherein the sensor cleaning event is initiated in response to a determination that one or more interest regions of the second plurality of images are stable.

Aspect 11. The computer-implemented method of any of Aspects 8 to 10, wherein computing the image statistics for each of the first plurality of image frames based on the one or more interest regions includes: generating a one-dimensional pixel array for each of the first plurality of image frames; and computing the image statistics for each of the first plurality of image frames based on the corresponding one-dimensional pixel array.

Aspect 12. The computer-implemented method of any of Aspects 8 to 11, wherein the sensor cleaning event is associated with timestamp metadata.

Aspect 13. The computer-implemented method of any of Aspects 8 to 12, wherein the sensor cleaning event comprises applying a cleaning solution to an optical lens of the optical sensor.

Aspect 14. The computer-implemented method of any of Aspects 8 to 13, wherein the optical sensor is a camera sensor.

Aspect 15. A non-transitory computer-readable storage medium comprising at least one instruction for causing a computer or processor to: receive a first plurality of image frames from an optical sensor; segment each of the first plurality of image frames into one or more interest regions; compute image statistics for each of the one or more interest regions; generate an image mask based on the image statistics for each of the one or more interest regions; receive a second plurality of image frames from the optical sensor; apply the image mask to the second plurality of image frames to produce a plurality of masked image frames; compute image statistics for each of the plurality of masked image frames; and determine a status of a sensor cleaning event based on the image statistics for each of the plurality of masked image frames.

Aspect 16. The non-transitory computer-readable storage medium of Aspect 15, wherein the second plurality of image frames are received in response to an indication that the sensor cleaning event has been initiated.

Aspect 17. The non-transitory computer-readable storage medium of Aspect 15 or 16, wherein the sensor cleaning event is initiated in response to a determination that one or more interest regions of the second plurality of images are stable.

Aspect 18. The non-transitory computer-readable storage medium of any of Aspects 15 to 17, wherein to compute the image statistics for each of the first plurality of image frames based on the one or more interest regions, the at least one processor is further configured to: generate a one-dimensional pixel array for each of the first plurality of image frames; and compute the image statistics for each of the first plurality of image frames based on the corresponding one-dimensional pixel array.

Aspect 19. The non-transitory computer-readable storage medium of any of Aspects 15 to 18, wherein the sensor cleaning event is associated with timestamp metadata.

Aspect 20. The non-transitory computer-readable storage medium of any of Aspects 15 to 19, wherein the sensor cleaning event comprises applying a cleaning solution to an optical lens of the optical sensor.

What is claimed is:

1. An apparatus comprising:
at least one memory; and
at least one processor coupled to the at least one memory, the at least one processor configured to:
receive a first plurality of image frames from an optical sensor;
segment each of the first plurality of image frames into one or more interest regions;
compute image statistics for each of the one or more interest regions;
generate an image mask based on the image statistics for each of the one or more interest regions;
receive a second plurality of image frames from the optical sensor;
apply the image mask to the second plurality of image frames to produce a plurality of masked image frames;
compute image statistics for each of the plurality of masked image frames; and
determine a status of a sensor cleaning event based on the image statistics for each of the plurality of masked image frames.

2. The apparatus of claim 1, wherein the second plurality of image frames are received in response to an indication that the sensor cleaning event has been initiated.

3. The apparatus of claim 1, wherein the sensor cleaning event is initiated in response to a determination that one or more interest regions of the second plurality of images are stable.

4. The apparatus of claim 1, wherein to compute the image statistics for each of the first plurality of image frames based on the one or more interest regions, the at least one processor is further configured to:
generate a one-dimensional pixel array for each of the first plurality of image frames; and
compute the image statistics for each of the first plurality of image frames based on the corresponding one-dimensional pixel array.

5. The apparatus of claim 1, wherein the sensor cleaning event is associated with timestamp metadata.

6. The apparatus of claim 1, wherein the sensor cleaning event comprises applying a cleaning solution to an optical lens of the optical sensor.

7. The apparatus of claim 1, wherein the optical sensor is a camera sensor.

8. A computer-implemented method for confirming a sensor cleaning event, comprising:
receiving a first plurality of image frames from an optical sensor;
segmenting each of the first plurality of image frames into one or more interest regions;
computing image statistics for each of the one or more interest regions;
generating an image mask based on the image statistics for each of the one or more interest regions;
receiving a second plurality of image frames from the optical sensor;
applying the image mask to the second plurality of image frames to produce a plurality of masked image frames;
computing image statistics for each of the plurality of masked image frames; and
determining a status of a sensor cleaning event based on the image statistics for each of the plurality of masked image frames.

9. The method of claim 8, wherein the second plurality of image frames are received in response to an indication that the sensor cleaning event has been initiated.

10. The method of claim 8, wherein the sensor cleaning event is initiated in response to a determination that one or more interest regions of the second plurality of images are stable.

11. The method of claim 8, wherein computing the image statistics for each of the first plurality of image frames based on the one or more interest regions includes:
generating a one-dimensional pixel array for each of the first plurality of image frames; and
computing the image statistics for each of the first plurality of image frames based on the corresponding one-dimensional pixel array.

12. The method of claim 8, wherein the sensor cleaning event is associated with timestamp metadata.

13. The method of claim 8, wherein the sensor cleaning event comprises applying a cleaning solution to an optical lens of the optical sensor.

14. The method of claim 8, wherein the optical sensor is a camera sensor.

15. A non-transitory computer-readable storage medium comprising at least one instruction for causing a computer or processor to:
receive a first plurality of image frames from an optical sensor;
segment each of the first plurality of image frames into one or more interest regions;
compute image statistics for each of the one or more interest regions;
generate an image mask based on the image statistics for each of the one or more interest regions;
receive a second plurality of image frames from the optical sensor;
apply the image mask to the second plurality of image frames to produce a plurality of masked image frames;
compute image statistics for each of the plurality of masked image frames; and
determine a status of a sensor cleaning event based on the image statistics for each of the plurality of masked image frames.

16. The non-transitory computer-readable storage medium of claim 15, wherein the second plurality of image frames are received in response to an indication that the sensor cleaning event has been initiated.

17. The non-transitory computer-readable storage medium of claim 15, wherein the sensor cleaning event is initiated in response to a determination that one or more interest regions of the second plurality of images are stable.

18. The non-transitory computer-readable storage medium of claim 15, wherein to compute the image statistics for each of the first plurality of image frames based on the one or more interest regions, the at least one processor is further configured to:
generate a one-dimensional pixel array for each of the first plurality of image frames; and
compute the image statistics for each of the first plurality of image frames based on the corresponding one-dimensional pixel array.

19. The non-transitory computer-readable storage medium of claim 15, wherein the sensor cleaning event is associated with timestamp metadata.

20. The non-transitory computer-readable storage medium of claim 15, wherein the sensor cleaning event comprises applying a cleaning solution to an optical lens of the optical sensor.
